(19) United States
(12) Patent Application Publication
(10) Pub. No.: US 2023/0418905 A1
(43) Pub. Date: Dec. 28, 2023

(54) BINARY REPRESENTATION FOR SPARSELY POPULATED SIMILARITY

(71) Applicant: Insight Direct USA, Inc., Tempe, AZ (US)

(72) Inventor: Scott Lowery, Scottsdale, AZ (US)

(21) Appl. No.: 17/903,436

(22) Filed: Sep. 6, 2022

Related U.S. Application Data
(60) Provisional application No. 63/355,431, filed on Jun. 24, 2022.

(51) Int. Cl. G06K 9/62; G06F 40/194

(52) U.S. Cl. CPC G06K 9/6215; G06F 40/194

(57) ABSTRACT

A method of measuring similarity for a sparsely populated dataset includes identifying fields in an initial dataset and generating a binary representation dataset that corresponds to the initial dataset by representing populated fields of the initial dataset with a first binary value and representing null fields of the initial dataset with a second binary value such that each of the fields in the initial dataset has a corresponding field in a corresponding position in the binary representation dataset. The method further includes calculating a similarity measure for one or more pairs of rows of the binary representation dataset; comparing each of the one or more pairs of rows of the binary representation dataset to a corresponding pair of rows in the initial dataset to identify similar pairs of rows in the initial dataset; and generating and outputting a recommendation of the similar pairs of rows in the initial dataset.

### BACKGROUND

Recommender (or “recommendation”) systems are used in a variety of industries to make recommendations or predictions based on other information. Common applications of recommender systems include making product recommendations to online shoppers, generating music playlists for listeners, recommending movies or television shows to viewers, recommending articles or other informational content to consumers, etc. One technique used in some recommender systems is content-based filtering, which attempts to identify items that are similar to items known to be of interest to a user based on an analysis of item content. Another technique used in some recommender systems is collaborative filtering, which recommends items based on the interests of a community of users, rather than based on the item content. Recommender systems (and other similar systems, such as classifier systems or the like) generally include some form of a similarity measure for determining the level of similarity between two things, e.g., between two items. The type of similarity measure used for a recommender system can depend on a number of different factors, such as a form of the data used or other factors.

### SUMMARY

In one example, a method of measuring similarity for a sparsely populated dataset includes identifying fields in an initial dataset, the initial dataset including populated fields and null fields. The method further includes generating, by a computer device, a binary representation dataset that corresponds to the initial dataset by representing the populated fields of the initial dataset with a first binary value and representing the null fields of the initial dataset with a second binary value such that each of the fields in the initial dataset has a corresponding field in a corresponding position in the binary representation dataset. The binary representation dataset is organized in rows and columns. The method further includes calculating a similarity measure for one or more pairs of rows of the binary representation dataset and comparing, based on the similarity measure, each of the one or more pairs of rows of the binary representation dataset to a corresponding pair of rows in the initial dataset to identify similar pairs of rows in the initial dataset. The method further includes generating a recommendation of the similar pairs of rows in the initial dataset and outputting the recommendation of the similar pairs of rows in the initial dataset.

In another example, a system for measuring similarity for a sparsely populated dataset includes an initial dataset that includes populated fields and null fields, one or more processors, and computer-readable memory encoded with instructions that, when executed by the one or more processors, cause the system to identify fields in the initial dataset and generate a binary representation dataset that corresponds to the initial dataset by representing the populated fields of the initial dataset with a first binary value and representing the null fields of the initial dataset with a second binary value such that each of the fields in the initial dataset has a corresponding field in a corresponding position in the binary representation dataset. The binary representation dataset is organized in rows and columns. The instructions further cause the system to calculate a similarity measure for one or more pairs of rows of the binary representation dataset and compare, based on the similarity measure, each of the one or more pairs of rows of the binary representation dataset to a corresponding pair of rows in the initial dataset to identify similar pairs of rows in the initial dataset. The instructions further cause the system to generate a recommendation of the similar pairs of rows in the initial dataset and output the recommendation of the similar pairs of rows in the initial dataset.

### BRIEF DESCRIPTION OF THE DRAWINGS

FIG. 1 is a block diagram showing details of a recommender system including a binary representation transformation.

FIG. 2 is a diagram illustrating a process for using the binary representation transformation with the recommender system.

FIG. 3A is a simplified table showing an example of an initial dataset.

FIG. 3B is a simplified table showing an example of a binary representation dataset that corresponds to the initial dataset of FIG. 3A.

FIG. 4 is a flowchart illustrating steps of a first example of a process for measuring similarity using the binary representation transformation.

FIG. 5 is a flowchart illustrating steps of a second example of a process for measuring similarity using the binary representation transformation and including a refinement step.

### DETAILED DESCRIPTION

Sparsely populated datasets (i.e., datasets containing a significant number of null or missing values) can be a result of combining or standardizing several datasets that include data items with at least some non-overlapping attributes between them. Current technologies for handling null or missing values in similarity measures, such as for recommender tools, are not suitable for sparsely populated datasets. According to techniques of this disclosure, transforming a dataset into a binary representation is used to capture the similarity in data population between two rows where null values exist while maintaining the individual characteristics of each row. This similarity score can be used as a reliable similarity measure itself, using the similar population of columns between two rows as an indication of the similarity between the rows.

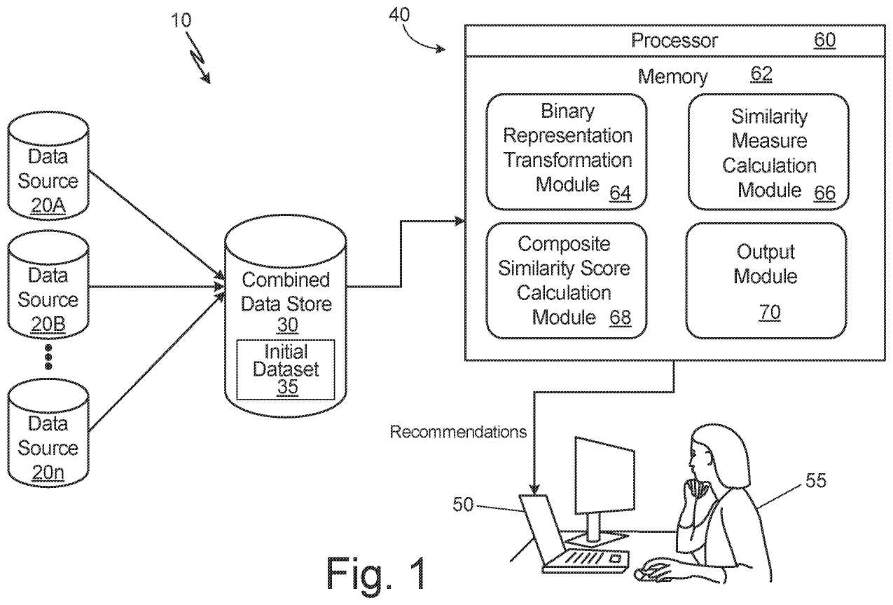

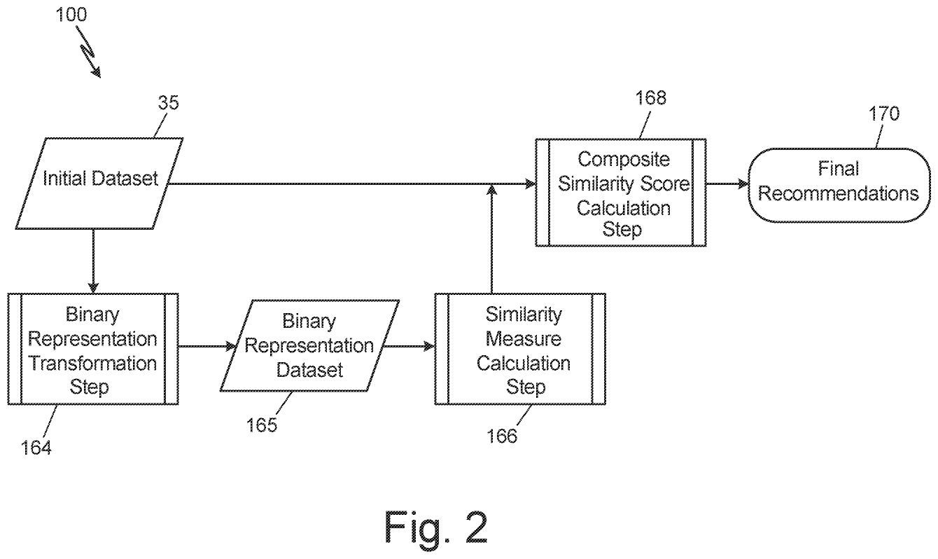

FIGS. 1 and 2 will be described together. FIG. 1 is a block diagram showing details of recommender system 10 including a binary representation transformation. FIG. 2 is a diagram illustrating process 100 for using the binary representation transformation with recommender system 10. As illustrated in FIG. 1, recommender system 10 includes data sources 20A-20n (“n” is used herein as an arbitrary integer to indicate any number of the referenced component), combined data store 30 (including initial dataset 35), data processing system 40, user interface 50, and users 55. Data processing system 40 includes processor 60 and memory 62. Data processing system 40 further includes binary representation transformation module 64, similarity measure calculation module 66, composite similarity score calculation module 68, and output module 70. As illustrated in FIG. 2, process 100 starts from initial dataset 35 and includes binary representation transformation step 164, binary representation dataset 165, similarity measure calculation step 166, composite similarity score calculation step 168, and final recommendations 170.

Recommender system 10 is a system for measuring similarity of items in a dataset and outputting the results. In particular, recommender system 10 can be a system for measuring similarity in sparsely populated datasets, as will be described in greater detail below. In one non-limiting example, recommender system 10 can be a business system for identifying similar parts in a business's inventory.

Data sources 20A-20n are stores or collections of electronic data. In some examples, data sources 20A-20n can be databases, such as Oracle databases, Azure SQL databases, or any other type of database. In other examples, data sources 20A-20n can be SharePoint lists or flat file types, such as Excel spreadsheets. In yet other examples, data sources 20A-20n can be any suitable store of electronic data. Individual ones of data sources 20A-20n can be the same type of data source or can be different types of data sources. Further, although three data sources 20A-20n are depicted in FIG. 1, other examples of recommender system 10 can include any number of data sources 20A-20n, including more or fewer data sources 20A-20n. System 10 can, in principle, include a large and scalable number of data sources 20A-20n. Data located in data sources 20A-20n can be structured (e.g., rows and columns), unstructured, or semi-structured. In some examples, data sources 20A-20n store inventory data for an organization. In other examples, data sources 20A-20n store any type of electronic data. Each of data sources 20A-20n can store a same or different type of data.

Combined data store 30 is a collection of electronic data. Combined data store 30 can be any suitable electronic data storage means, such as a database, data warehouse, data lake, flat file, or other data storage type. More specifically, combined data store 30 can be any type of electronic data storage that can maintain relationships between individual items or instances of data and attributes of those data items. In one example, combined data store 30 stores data collected from data sources 20A-20n. That is, combined data store 30 can be a standardized and centralized database where several standardized data structures, including one or more non-overlapping attributes (i.e., some similar and some dissimilar attributes), are combined for faster and easier querying. In other examples, data is stored directly in combined data store 30 rather than aggregated from data sources 20A-20n. In some examples, combined data store 30 can be an “on-premises” data store (e.g., within an organization's data centers). In other examples, combined data store 30 can be a “cloud” data store that is available using cloud services from vendors such as Amazon, Microsoft, or Google. Electronic data stored in combined data store 30 is accessible by data processing system 40.

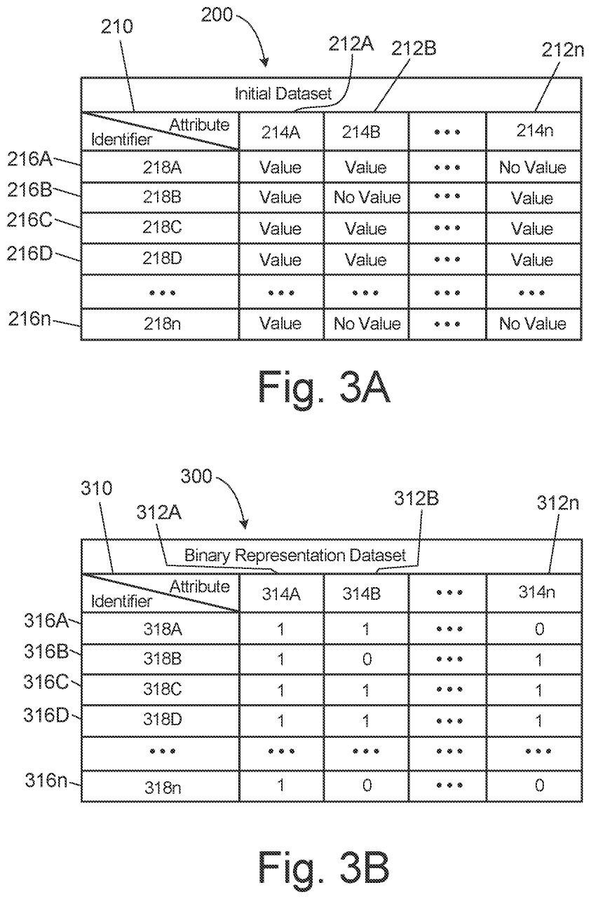

All or a portion of the data in combined data store 30 makes up initial dataset 35. Initial dataset 35 can take the form of a matrix or table or other similar data structure suitable for maintaining relationships between individual items or instances of data and attributes of those data items. As will be described in greater detail below with reference to FIG. 3A, initial dataset 35 can include any number of rows and columns, and, therefore, any number of fields, such as hundreds, thousands, ten thousand, etc. Additionally, initial dataset 35 can include both populated fields (i.e., fields that contain a value) and unpopulated or “null” fields (i.e., fields that do not contain a value). Null fields may be the result of missing data in a field or fields that do not have a value. Values in the fields of initial dataset 35 can be numerical values, string or character values, Boolean values, etc. In some examples, multiple types of data (numerical, string or character, Boolean, etc.) can be used throughout initial dataset 35. In other examples, initial dataset 35 can include only one type of data. In some examples, initial dataset 35 can be a sparsely populated dataset. That is, several rows and/or columns of initial dataset 35 can contain a significant number of null fields. In some examples, each row of initial dataset 35 can contain at least one null field. In some examples, each column of initial dataset 35 can contain null fields in at least 50% of the rows. In some examples, each row of initial dataset 35 can contain null fields in at least 50% of the columns. For example, initial dataset 35 can be a combined dataset formed of data from multiple of data sources 20A-20n and including rows representing different data items with disparate or non-overlapping attributes. In one non-limiting example, initial dataset 35 can include collective inventory data for multiple product lines of a business. In some examples, initial dataset 35 can be a refined or transformed dataset or can be a subset of a larger dataset within combined data store 30. For example, a user could select a portion of the data stored in combined data store 30 (e.g., a portion that corresponds to certain ones of data sources 20A-20n) to use as initial dataset 35. Any refinements or transformations in such examples can be based on subject matter-specific logic for identifying data of interest for a particular application.

Data processing system 40 is a sub-system of recommender system 10 for processing data in recommender system 10. Process 100, shown in FIG. 2, is carried out by data processing system 40. In some examples, data processing system 40 can receive inputs from a user, such as an input from a user to select a data item of interest for process 100. For example, if initial dataset 35 contains inventory data for a number of parts, a user could input a selection of one part (which corresponds to one row in initial dataset 35), so that process 100 can be carried out for that part (a single row) rather than the entirety of initial dataset 35 (many rows).

Data processing system 40 includes processor 60 and memory 62. Although processor 60 and memory 62 are illustrated in FIG. 1 as being separate components of a single computer device, it should be understood that in other examples, processor 60 and memory 62 can be distributed among multiple connected devices. In other examples, memory 62 can be a component of processor 60. In some examples, data processing system 40 is a wholly or partially cloud-based system, and, therefore, process 100 can be a wholly or partially cloud-based process.

Processor 60 is configured to implement functionality and/or process instructions within data processing system 40. For example, processor 60 can be capable of processing instructions stored in memory 62. Examples of processor 60 can include one or more of a processor, a microprocessor, a controller, a digital signal processor (DSP), an application specific integrated circuit (ASIC), a field-programmable gate array (FPGA), or other equivalent discrete or integrated logic circuitry.

Memory 62 can be configured to store information before, during, and/or after operation of data processing system 40. Memory 62, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 62 can be entirely or partly temporary memory, meaning that a primary purpose of memory 62 is not long-term storage. Memory 62, in some examples, is described as volatile memory, meaning that memory 62 does not maintain stored contents when power to devices (e.g., hardware of data processing system 40) is turned off. Examples of volatile memories can include random access memories (RAM), dynamic random access memories (DRAM), static random access memories (SRAM), and other forms of volatile memories. Memory 62, in some examples, also includes one or more computer-readable storage media. Memory 62 can be configured to store larger amounts of information than volatile memory. Memory 62 can further be configured for long-term storage of information. In some examples, memory 62 includes non-volatile storage elements. Examples of such non-volatile storage elements can include magnetic hard discs, optical discs, flash memories, or forms of electrically programmable memories (EPROM) or electrically erasable and programmable (EEPROM) memories.

Memory 62 is encoded with instructions that are executed by processor 60. For example, memory 62 can be used to store program instructions for execution by processor 60. In some examples, memory 62 is used by software or applications running on processor 60 to temporarily store information during program execution.

As illustrated in FIG. 1, data processing system 40 can be further divided functionally into modules. Specifically, data processing system 40 can include binary representation transformation module 64, similarity measure calculation module 66, composite similarity score calculation module 68, and output module 70. Each functional module of data processing system 40 can be a collection of computer code in any suitable programming language. In some examples, each functional module of data processing system 40 can be part of a computer program itself (i.e., written in code). In other examples, each functional module of data processing system 40 can be a functional representation of a portion of a computer program executing code based on a configuration. Moreover, although depicted in FIG. 1 as components of data processing system 40, each of binary representation transformation module 64, similarity measure calculation module 66, composite similarity score calculation module 68, and/or output module 70 can also be independently carried out, e.g., on a corresponding dedicated computer device.

Binary representation transformation module 64 is a first functional module of data processing system 40. Binary representation transformation module 64 includes methods in code for performing binary representation transformation step 164 (FIG. 2). Binary representation transformation step 164 can be considered a pre-processing step for similarity measure calculation step 166 and composite similarity score calculation step 168. As illustrated in FIG. 2, process 100 starts from initial dataset 35, and, in a first step, binary representation transformation module 64 transforms initial dataset 35 into binary representation dataset 165 via binary representation transformation step 164. More specifically, binary representation transformation module 64 can identify, for each field of initial dataset 35, whether an individual field contains a value or does not contain a value (i.e., whether an individual field is populated or null). In the case where one or more columns of initial dataset 35 contain Boolean values, binary representation transformation module 64 can treat both a Boolean “true” value and a Boolean “false” value in fields as populated fields, the idea being that a Boolean “false” value still contains more information than a field that contains no value at all. Alternatively, binary representation transformation module 64 can treat a Boolean “true” value in a field as a populated field and can treat a Boolean “false” value in a field as being effectively a null field. Binary representation transformation module 64 forms binary representation dataset 165 based on initial dataset 35 by replacing all null fields in initial dataset 35 with a binary value of zero (“0”) and replacing all populated fields with a binary value of one (“1”). Accordingly, binary representation dataset 165 can be fully populated with the binary values (compared to initial dataset 35 which may have a significant number of null fields). The binary values in binary representation dataset 165 can be numerical values or textual values. For numerical values, the binary values in binary representation dataset 165 make up a two-dimensional matrix having ones and zeroes. Binary representation dataset 165 can be temporarily stored separately from initial dataset 35. For example, binary representation dataset 165 may be temporarily stored and available in memory 62 for use within data processing system 40.

Each field in initial dataset 35 has a corresponding field in binary representation dataset 165. In other words, binary representation dataset 165 has the same dimensions (e.g., the same number of rows and columns) as initial dataset 35. Binary representation transformation module 64 also maintains an identifier or key for each data item from initial dataset 35 and its corresponding attributes. For example, a first column in initial dataset 35 can include an identifier for each data item, such as a name, an identification number or code, or other key value. Binary representation transformation module 64 can maintain the first column from initial dataset 35 as the key for binary representation dataset 165.

Similarity measure calculation module 66 is a second functional module of data processing system 40. Similarity measure calculation module 66 includes methods in code for performing similarity measure calculation step 166 (FIG. 2). In some examples, composite similarity score calculation module 68 is configurable. As illustrated in FIG. 2, similarity measure calculation step 166 is a next step of process 100 after binary representation transformation step 164.

Similarity measure calculation module 66 performs similarity measure calculation step 166 on binary representation dataset 165. Similarity measure calculation module 66 takes a cross of the binary matrix of binary representation dataset 165, comparing each data item (i.e., each row) to every other data item in binary representation dataset 165 to calculate a similarity measure for each combination. In some examples, similarity measure calculation module 66 can iterate through every possible pair of rows in binary representation dataset 165. In other examples, similarity measure calculation module 66 can iterate through pairs of rows in a selected portion of binary representation dataset 165. In yet other examples, similarity measure calculation module 66 can use a user input to data processing system 40 to select one data item (and the row to which the data item corresponds) to compare only that row with every other row in binary representation dataset 165. For n number of rows (where “n” is an arbitrary integer representing any integer) in binary representation dataset 165, there are n²−n possible unique comparisons between pairs of rows. Each pair of rows in binary representation dataset 165 can be compared using any suitable type of similarity measure known in the art. For example, when the binary values in binary representation dataset 165 are numerical values, Cosine similarity can be used as the similarity measure. In other examples, when the binary values are textual values, such as string or character values, Levenshtein distance can be used as the similarity measure. In yet other examples, any suitable similarity measure can be used.

When two rows in binary representation dataset 165 are compared to determine similarity, the chosen similarity measure produces a value (or score) that represents the level of similarity between the pair of rows. For example, the level of similarity can be represented as a score on a predetermined scale (e.g., from zero to one), a classification (e.g., using categories such as “highly similar,” “somewhat similar,” “neutral,” “somewhat dissimilar,” and “highly dissimilar”), a binary determination (e.g., “similar” or “not similar”), etc. The level of similarity is based on the relative population of the fields in the two rows being compared. Two rows with similar fields populated will have higher similarity, whereas two rows with dissimilar fields populated will have lower similarity. Thus, the primary similarity is derived from which information is there (populated fields) and which information is not there (null fields), as opposed to the explicit contents of each field in initial dataset 35. In other words, the individual characteristics of the rows are maintained (are not lost or flattened) by the similarity measure.

Once the similarity measure is calculated via similarity measure calculation module 66, pairs of rows in binary representation dataset 165 can be compared back to corresponding rows in initial dataset 35. For example, a user can review the actual values in rows of initial dataset 35 that correspond to rows in binary representation dataset 165 that were identified by the similarity measure as having a relatively high level of similarity. In another example, all pairs of rows in binary representation dataset 165 can be compared to the corresponding pairs of rows in initial dataset 35. In yet other examples, data processing system 40 can include methods for automatically associating pairs of rows in binary representation dataset 165 with corresponding pairs of rows in initial dataset 35. Comparing pairs of rows in binary representation dataset 165 to corresponding pairs of rows in initial dataset 35 is a way of mapping the similarity measure calculated in similarity measure calculation module 66 to the actual data in initial dataset 35, e.g., to identify similar pairs of rows in initial dataset 35. Comparing pairs of rows in binary representation dataset 165 to corresponding pairs of rows in initial dataset 35 can be accomplished using the key column as a reference to link the corresponding rows. There will be a corresponding row in initial dataset 35 that has the same identifier or key in the key column as a row in binary representation dataset 165, and each binary value in the row in binary representation dataset 165 will correspond directly to a field that is either populated or null in initial dataset 35. In this way, the similarity measure calculated by similarity measure calculation module 66 can be considered a similarity measure both of pairs of rows in binary representation dataset 165 and of corresponding pairs of rows in initial dataset 35.

The level of similarity (i.e., the similarity measure) between pairs of rows in binary representation dataset 165 (and initial dataset 35) and/or an identification of similar pairs of rows in initial dataset 35 can be the output of similarity measure calculation module 66. The output of similarity measure calculation module 66 can be used directly as a basis for recommendations to a user or as an input into other data tools. In some examples, the output of similarity measure calculation module 66 can also be used as a measure of the quality of initial dataset 35, e.g., if similarities between data items in initial dataset 35 are already known or if certain information is expected to be present in initial dataset 35. For instance, a subject matter expert may identify an individual field as important that, consequently, should be populated or may expect most fields in the dataset to be populated. Additionally, the proportion of valid crosses of rows that would be possible for initial dataset 35 (which decreases when there are null fields) to valid crosses for binary representation dataset 165 (which is all possible crosses of rows as all fields are populated with binary values) can be an indication of the relative strength and overall population integrity of the dataset.

Composite similarity score calculation module 68 is a third functional module of data processing system 40. Composite similarity score calculation module 68 includes methods in code for performing composite similarity score calculation step 168 (FIG. 2). In some examples, composite similarity score calculation module 68 is configurable. As illustrated in FIG. 2, composite similarity score calculation step 168 is a next step of process 100 after similarity measure calculation step 166.

Composite similarity score calculation step 168 combines information from the branch of process 100 that forms binary representation dataset 165 and the original branch of process 100 that includes initial dataset 35. At this point in process 100, the output of similarity measure calculation step 166 can be refined or adjusted into a composite similarity score. In some examples, the individual similarity measure for a pair of rows compared by similarity measure calculation module 66 can be refined in composite similarity score calculation step 168. In other examples, composite similarity score calculation step 168 can be a refinement or adjustment to all or a group of the similarity measures.

Composite similarity score calculation step 168 can include applying different weights (e.g., penalizing or boosting) or setting threshold requirements for certain attributes of initial dataset 35 based on the actual values in initial dataset 35. For example, one attribute in initial dataset 35 can be an input voltage, and each row might have a value in the input voltage column (so all fields in the input voltage column are populated in both initial dataset 35 and binary representation dataset 165), but a particular configuration of composite similarity score calculation module 68 may include an instruction that only a limited range of voltages in the input voltage column should actually be considered sufficiently similar. In some examples, composite similarity score calculation module 68 can include machine learning algorithms for filtering the data. In one example, a machine learning algorithm could be trained using binary representation dataset 165 to determine important attributes based on how populated the fields are for that attribute.

In some examples, composite similarity score calculation step 168 can also include disqualifying or excluding pairs of rows that were indicated as having relatively high similarity for other reasons not based on the population of the rows. For example, composite similarity score module 68 can be configured to filter the results from similarity measure calculation step 166 if some attributes in initial dataset 35 are considered not very predictive of similarity (e.g., because they may be generic attributes that are widely shared for data items in initial dataset 35). In another example, a pair of rows in binary representation dataset 165 might have high similarity based strictly on overall population, but composite similarity score module 68 can be configured to disqualify the pair of rows based on a mismatch for one or more specific attributes, despite the otherwise high similarity of population between the rows. A mismatch can represent a situation where one row is populated and the other row is null for a particular attribute in binary representation dataset 165 or a situation where the actual values in initial dataset 35 for each row in the pair are different for a particular attribute. To illustrate, in an example where initial dataset 35 includes inventory data for integrated circuit parts, many parts may have lots of similar attributes, but if two parts have a different input voltage, then it may not be desired to identify the two parts as similar.

Accordingly, the similarity measure calculated in similarity measure calculation step 166 can be a first estimate of similarity between rows of binary representation dataset 165 (and corresponding rows in initial dataset 35), and real data from initial dataset 35 can be used to refine this estimate in composite similarity score calculation step 168. That is, a composite similarity score is generated by informing the similarity measure produced in similarity measure calculation step 166 with more specific information about initial dataset 35. Refining the results in composite similarity score calculation step 168 (i.e., after calculating an initial similarity measure in similarity measure calculation step 166) focuses process 100 on important elements of initial dataset 35 and applies the proper weight to those elements without having this weighting overwhelm the similarity measure. In other examples, initial dataset 35 can be refined or adjusted prior to binary representation transformation step 164 rather than after similarity measure calculation step 166. Any refinements in the examples described above can be based on subject matter-specific logic for identifying data of interest for a particular application. The composite similarity score for pairs of rows in initial dataset 35 (and corresponding pairs of rows in binary representation dataset 165) is the output of composite similarity score calculation module 68.

Output module 70 is a fourth functional module of data processing system 40. Output module 70 includes methods in code for communicating recommendations (e.g., final recommendations 170, as shown in FIG. 2) from data processing system 40 in recommender system 10. That is, output module 70 can perform a final step of process 100 by communicating final recommendations 170 (FIG. 2).

Final recommendations 170 can take several different forms and are generated based on outputs from data processing system 40. As described above, outputs from data processing system 40 can be produced from either similarity measure calculation module 66 or composite similarity score calculation module 68. For example, output module 70 can generate and communicate final recommendations 170 based on outputs from composite similarity score calculation module 68. In such examples, final recommendations 170 are generated based on the composite similarity score, which is in turn based on the pairs of rows initially identified as similar in initial dataset 35 by the similarity measure. In other examples, output module 70 can generate and communicate final recommendations 170 based on outputs from similarity measure calculation module 66 rather than composite similarity score calculation module 68. That is, outputs from similarity measure calculation module 66 may be used directly instead of undergoing additional transformations or refinements via composite similarity score calculation module 68 described above. In such examples, final recommendations 170 are generated based on the similarity measure and/or the corresponding pairs of rows identified as similar in initial dataset 35.

In some examples, output module 70 can communicate final recommendations 170 to user interface 50. In other examples, output module 70 can store final recommendations 170, e.g., in a database or other data store. In yet other examples, output module 70 can communicate final recommendations 170 to be used as an input for another data processing system or tool for further data processing, to be incorporated with other data, etc.

User interface 50 is communicatively coupled to data processing system 40 to enable users 55 to interact with data processing system 40, e.g., to receive outputs from data processing system 40 or to input a selection of a data item of interest for generating recommendations. User interface 50 can include a display device and/or other user interface elements (e.g., keyboard, buttons, monitor, graphical control elements presented at a touch-sensitive display, or other user interface elements). In some examples, user interface 50 can take the form of a mobile device (e.g., a smart phone, a tablet, etc.) with an application downloaded that is designed to connect to data processing system 40. In some examples, user interface 50 includes a graphical user interface (GUI) that includes graphical representations of final recommendations 170 from output module 70. For example, final recommendations 170 can be displayed via user interface 50 in a user-friendly form, such as in an ordered list based on similarity. In one non-limiting example, users 55 are business users who will review and use final recommendations 170.

Final recommendations 170 can be the overall output of data processing system 40 and recommender system 10. In general, final recommendations 170 are based on similar pairs of rows in initial dataset 35, as determined from corresponding pairs of rows in binary representation dataset 165. Final recommendations 170 are also based on either the similarity measure calculated by similarity measure calculation module 66 or the composite similarity score calculated by composite similarity score calculation module 68. In one non-limiting example, final recommendations 170 can include a recommendation of similar products within a business's inventory. The content and form of final recommendations 170 can depend largely on the particular application of recommender system 10. While contemplated as part of a “recommender system” for generating and outputting recommendations to users, it should be understood that binary representation transformation step 164—and similarity measure calculation step 166 performed thereon—can also be used in other systems, such as systems for evaluating the quality of data, etc. In these other examples, final recommendations 170 can represent the output of similarity measure calculation module 66 in whatever form would be suitable for additional analysis of the data in initial dataset 35.

According to techniques of this disclosure, binary representation transformation step 164 permits similarity measures to be performed effectively on sparsely populated datasets (e.g., initial dataset 35). Current methods for measuring similarity between two rows of data in a dataset do not include an intuitive way to handle null or missing values. When these similarity measures are used in a tool like a recommender system, the tool will fail to generate accurate recommendations if the data has significant gaps in population. In a sparsely populated dataset (namely, a dataset where each row and column contain a significant number of null values), the reliability of recommender systems or other tools built on similarity measures decays exponentially. When a recommender system takes a cross of every row in whatever subset of data is being analyzed, missing data in one row compromises the cross of that row with every other row. In a dataset of n rows, missing data in one row compromises n−1 row comparisons using traditional methods. This problem is exacerbated further when that same logic is applied to missing data in numerous columns. Eventually, a sparsely populated dataset leaves traditional similarity measures used in recommender systems crippled.

Current technologies attempt to solve this problem through one of two methods. A first traditional method is to ignore all rows with null or missing data. This method identifies every row in the dataset that has a value missing and excludes that row from the comparison. No similarity measure is calculated between two rows if either of the rows has a null value in one of its columns. Ignoring the rows with null or missing data makes calculating similarity measures on a dataset where every row contains some null values impossible. As the number of rows impacted by missing values increases exponentially (as every row is crossed with every other row in the dataset), the total number of rows able to be compared decays exponentially. This decay also causes a decrease in (a) the likelihood that a recommendation is accurate, as a recommender model must choose from a much smaller subset of rows, and (b) the overall utility of the recommender tool, as the tool does not provide a comprehensive analysis of each item, even if some data is present.

A second traditional method is to impute the value of a null field with some default value. In the case of numerical fields, this value is often a mean or median value associated with that field, and for string or character fields, there is some default value assigned to the field. For instance, a null in a field that captured a numeric characteristic, such as an input voltage, may be populated by the average input voltage across the whole dataset. There are many methods of imputation, but all of them “fill” missing values with data imputed from populated fields in that dataset. While imputing null values with a certain default value is a more popular approach, there are also limitations that make this method inadequate in a sparsely populated dataset. If a dataset has many null values for a particular attribute, then most of the rows will end up with the same, artificially assigned value. If this trend is consistent across several columns, rows become closer and closer to the “average” row. Consequently, rows will be judged as similar by a similarity measure—and potentially recommended by a recommender system that uses the similarity measure—simply because the rows each have significant missing data, as opposed to having any concrete similarity in the data that is present. Thus, the imputation method also fails to accurately capture similarity if data population is relatively low.

Recommender system 10, including binary representation transformation step 164, however, uses an identification of populated fields in initial dataset 35 as a measure of similarity. In a dataset with nulls in many of the columns, the idea is that rows with similar characteristics are more likely similar items. This allows several advantages. First, performing similarity measure calculation step 166 on binary representation dataset 165 can provide comparisons between rows with null values, as opposed to ignoring any rows with null values. This empowers recommender systems that are based on sparsely populated datasets. Another advantage is that a similarity measure capable of handling nulls without imputing or assuming certain elements of data ensures that similarity is being determined based on the nature of the individual data items (rows) being crossed, as opposed to comparing any individual item to an artificial average item. Binary representation transformation step 164 allows for flexibility in heavily standardized and centralized databases (e.g., combined data store 30), where several different standardized tables (with some similar and some dissimilar elements from other tables) are combined, while also still allowing for recommender systems to function effectively. This is applicable to organizations with big data applications. Binary representation transformation step 164 also provides a solution for databases with poor data quality, such as databases including datasets with missing data or improperly formatted data. Binary representation transformation step 164 can be used capture similarity without first relying on optimal quality data. This provides real-world utility, as data is rarely complete. Moreover, binary representation transformation step 164 can be used to capture similarity for datasets where classification information to categorize the data is not known or well understood prior to determining similarity. Overall, recommender system 10, including binary representation transformation step 164, provides flexibility and accurate similarity measurements for sparse and low-quality datasets that is not possible with current technologies.

FIGS. 3A and 3B will be described together. FIG. 3A shows table 200, which is an example of initial dataset 35. FIG. 3B shows table 300, which is an example of binary representation dataset 165 and which corresponds to table 200 of FIG. 3A. Tables 200 and 300 are simplified tables to illustrate an example of initial dataset 35 and binary representation dataset 165, which can be very large datasets having thousands of rows and/or columns. As illustrated in FIG. 3A, table 200 includes identifier column 210, columns 212A-212n for corresponding attributes 214A-214n, and rows 216A-216n for corresponding IDs 218A-218n. As illustrated in FIG. 3B, table 300 includes identifier column 310, columns 312A-312n for corresponding attributes 314A-314n, and rows 316A-316n for corresponding IDs 318A-318n.

As illustrated in FIG. 3A, table 200 is an initial dataset. Table 200 is an example of initial dataset 35 (FIGS. 1-2), and table 200 can have any or all the characteristics described above with respect to initial dataset 35. Table 200 includes a grid of fields that can be identified by a row (one of rows 216A-216n) and a column (one of columns 212A-212n). The fields in table 200 are either populated or unpopulated (null). As illustrated in FIG. 3A, populated fields are marked with “Value,” and null fields are marked with “No Value.” Populated fields can contain numerical values, string or character values, and/or Boolean “true” values. Null fields are missing, empty, and/or contain Boolean “false” values.

Identifier column 210 is a first column of table 200. Identifier column 210 is a key column for identifying data items in table 200. The fields of identifier column 210 are populated by IDs 218A-218n. Each of IDs 218A-218n can be a name, identification number or code, or other key value associated with a corresponding row (one of rows 216A-216n) of data (i.e., a corresponding data item and its attributes). As illustrated in FIG. 3A, ID 218A corresponds to row 216A, ID 218B corresponds to row 216B, ID 218C corresponds to row 216C, ID 218D corresponds to row 216D, and ID 218n corresponds to row 216n.

Each of columns 212A-212n represents an attribute for items of data stored in table 200. That is, each of columns 212A-212n has a corresponding attribute 214A-214n. As illustrated in FIG. 3A, attribute 214A corresponds to column 212A, attribute 214B corresponds to column 212B, and attribute 214n corresponds to column 212n. Attributes 214A-214n are characteristics of the data in table 200. For example, attributes 214A-214n can be qualitative characteristics, quantitative characteristics, or any other attribute types. The attribute type for each of attributes 214A-214n can prescribe a data type for the fields in the corresponding column 212A-212n, such as numerical, string or character, Boolean, etc. To illustrate, in one non-limiting example, attribute 214A could be an input voltage, and fields in column 212A could be populated with numerical values of input voltage. Although FIG. 3A shows table 200 having three columns 212A-212n, other examples can include any number of columns, such as hundreds, thousands, ten thousand, etc. In some examples, the number of columns 212A-212n in table 200 can depend on a combined or standardized set of attributes for items of data from various sources (e.g., data sources 20A-20n). Each of columns 212A-212n includes a total number of fields that is equal to the number of rows 216A-216n in table 200.

Each of rows 216A-216n represents an instance or item of data and its corresponding attributes. Although FIG. 3A shows table 200 having five rows 216A-216n, other examples can include any number of rows, such as hundreds, thousands, ten thousand, etc. A total number of rows 216A-216n is a total number of data items in table 200. As described above, each of rows 216A-216n can be identified by a corresponding ID 218A-218n in identifier column 210. Each of rows 216A-216n includes a total number of fields that is equal to the number of columns 212A-212n in table 200. In the example shown in FIG. 3A, row 216A has a populated field in column 212A, a populated field in column 212B, and a null field in column 212n (“Value,” “Value,” “No Value”). Accordingly, attributes 214A and 214B were used to characterize the data item corresponding to ID 218A, but attribute 214n was not used. Row 216B has a populated field in column 212A, a null field in column 212B, and a populated field in column 212n (“Value,” “No Value,” “Value”). Accordingly, attributes 214A and 214n were used to characterize the data item corresponding to ID 218B, but attribute 214B was not used. Rows 216C and 216D have a populated field in column 212A, a populated field in column 212B, and a populated field in column 212n (“Value,” “Value,” “Value”). Accordingly, attributes 214A, 214B, and 214n were all used to characterize the data items corresponding to ID 218C and ID 218D. Row 216n has a populated field in column 212A, a null field in column 212B, and a null field in column 212n (“Value,” “No Value,” “No Value”). Accordingly, attribute 214A was used to characterize the data item corresponding to ID 218n, but attributes 214B and 214n were not used. For example, the data item corresponding to ID 218n may have been added to table 200 from a different data source than the data items corresponding to ID 218C and ID 218D because row 216n and rows 216C and 216D have a different pattern of populated fields for columns 212B and 212n. Likewise, the data item corresponding to ID 218C and the data item corresponding to ID 218D may have been added to table 200 from the same data source because rows 216C and 216D have the same pattern of populated fields for columns 212B and 212n.

As illustrated in FIG. 3B, table 300 is an example of a binary representation dataset. More specifically, table 300 is a binary representation dataset that is formed from a binary representation transformation step performed on table 200 (FIG. 3A). Accordingly, table 300 is an example of binary representation dataset 165 (FIG. 2), and table 300 can have any or all the characteristics described above with respect to binary representation dataset 165.

Identifier column 310 is a first column of table 300. Identifier column 310 is maintained from table 200. That is, the values in identifier column 210 are not transformed into binary values, and identifier column 310 is the same as identifier column 210. In this way, identifier columns 210 and 310 can be used together as a key for comparing corresponding rows between table 200 and table 300.

Table 300 has the same dimensions as table 200. In other words, table 300 has the same number of rows 316A-316n as rows 216A-216n in table 200, and table 300 has the same number of columns 312A-312n as columns 212A-212n in table 200. In one example, rows 316A-316n are in the same position (order) as corresponding rows 216A-216n, and columns 312A-312n are similarly in the same position as corresponding columns 212A-212n. Moreover, each field in table 200 corresponds to a single field in table 300. In one example, each field in table 300 is in the same grid position as the field to which it corresponds in table 200.

The fields in table 300 represent the population of the fields in table 200 with binary values rather than the actual values. All populated fields in table 200 (i.e., fields containing “Value”) are represented in the corresponding field in table 300 with a binary value of one (“1”). All null fields in table 200 (i.e., fields containing “No Value”) are represented in the corresponding field in table 300 with a binary value of zero (“0”). Accordingly, row 316A has a one in column 312A, a one in column 213B, and a zero in column 312n (“1,” “1,” “0”). Row 316B has a one in column 312A, a zero in column 213B, and a one in column 312n (“1,” “0,” “1”). Rows 316C and 316D each have a one in column 312A, a one in column 213B, and a one in column 312n (“1,” “1,” “1”). Row 316n has a one in column 312A, a zero in column 213B, and a zero in column 312n (“1,” “0,” “0”). The binary values in table 300 can be numerical values or textual values. As described above, the type of value in table 300 determines the type of similarity measure that can be used to compare pairs of rows in table 300.

For example, rows 316C and 316D of table 300 have the same pattern (“1,” “1,” “1”) of binary values and may be identified by a similarity measure performed on table 300 as being highly similar. Rows 316C and 316D can be compared back to corresponding rows 216C and 216D in table 200 using ID 318C (ID 218C) and ID 318D (ID 218D). Corresponding rows 216C and 216D in table 200 could then be determined to be highly similar based on the similar population of fields in those rows. In contrast, row 316n in table 300 has a different pattern (“1,” “0,” “0”) of binary values, so corresponding row 216n in table 200 would likely be determined to be less similar to each of rows 216C and 216D than rows 216C and 216D are to each other.

The transformation of table 200 (an initial dataset) into table 300 (a binary representation dataset) can be used as a pre-processing step for generating accurate similarity measurements from sparse and low-quality datasets.

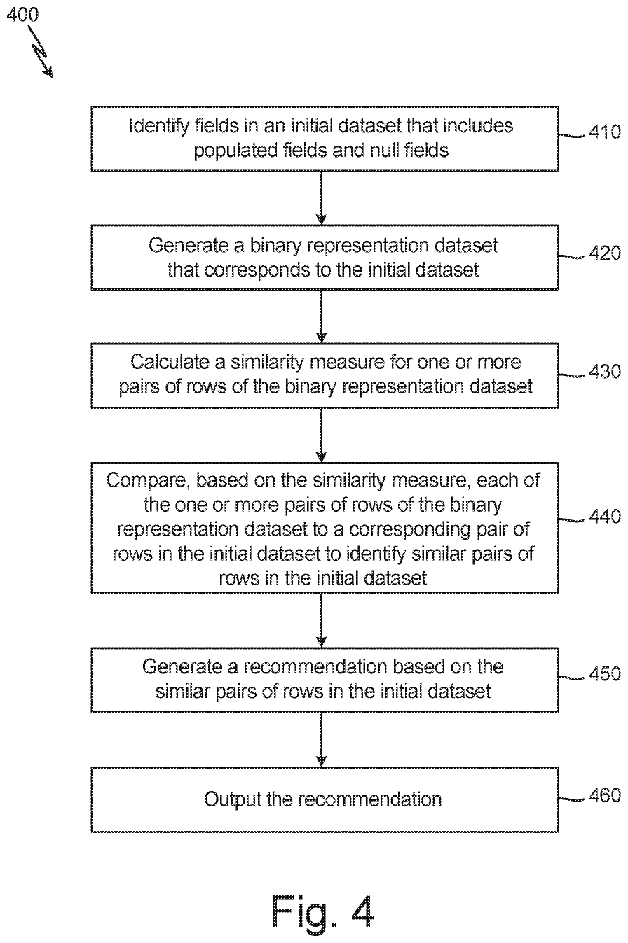

FIG. 4 is a flowchart illustrating steps 410-460 of process 400 for measuring similarity using the binary representation transformation. Process 400 will be described with reference to components of recommender system 10 described above (FIGS. 1-3B).

As illustrated in FIG. 4, a first step of process 400 is to identify fields in initial dataset 35, which includes populated fields and null fields (step 410). At step 420, binary representation dataset 165 is generated. As described above, binary representation dataset 165 corresponds to initial dataset 35. Steps 410-420 can be carried out by binary representation transformation module 64 in binary representation transformation step 164 (FIGS. 1-2).

At step 430, a similarity measure is calculated for one or more pairs of rows of binary representation dataset 165. The similarity measure can be calculated for each possible pair of rows in the entire binary representation dataset 165, or the similarity measure can be calculated for each pair of rows in a selected portion of binary representation dataset 165. Step 430 can be carried out by similarity measure calculation module 66 in similarity measure calculation step 166 (FIGS. 1-2).

At step 440, each of the one or more pairs of rows in binary representation dataset 165 is compared, based on the similarity measure calculated in step 430, to a corresponding pair of rows in initial dataset 35 to identify similar pairs of rows in initial dataset 35. For example, pairs of rows in binary representation dataset 165 that are determined to be highly similar can be linked back to the corresponding rows in initial dataset 35 that include actual values. Step 440 can be a manual step performed by a user or an automated step based on stored links between corresponding rows in initial dataset 35 and binary representation dataset 165. In one example, initial dataset 35 and binary representation dataset 165 are linked by a key column that is preserved between the two datasets.

At step 450, a recommendation is generated based on the similar pairs of rows in initial dataset 35. At step 460, the recommendation generated in step 450 is output. Steps 450-460 can be carried out by output module 70 (FIG. 1). The recommendation can be an example of final recommendations 170 (FIG. 2). Step 460 can be a final step of process 400. Although illustrated as single steps, it should be understood that each of steps 410-460 can be repeated any number of times in process 400.

Process 400, including step 420 for generating a binary representation dataset, provides flexibility and accurate similarity measurements for sparse and low-quality datasets that is not possible with current technologies.

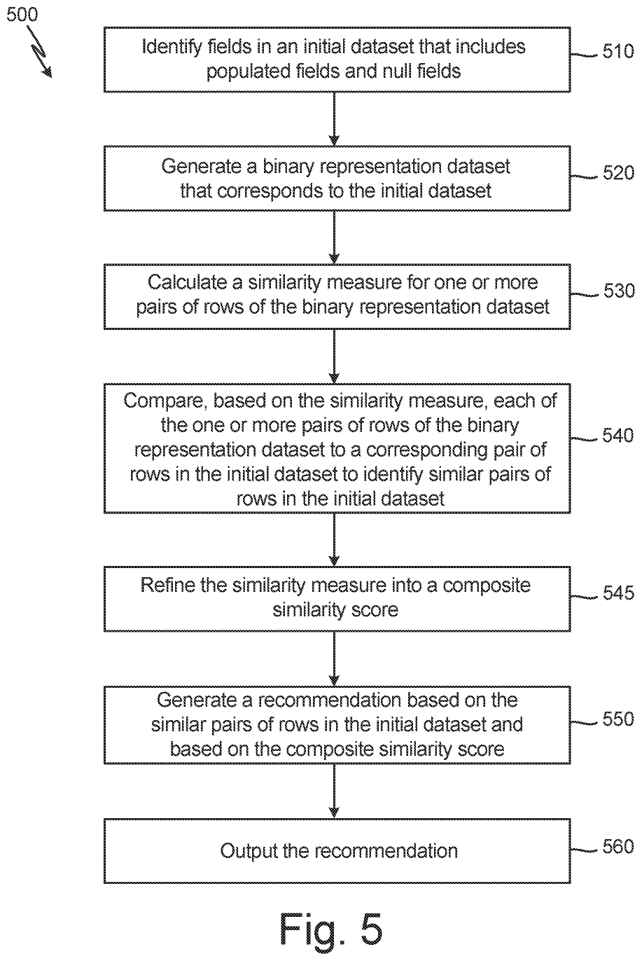

FIG. 5 is a flowchart illustrating steps 510-560 of process 500 for measuring similarity using the binary representation transformation and including a refinement step. Process 500 will be described with reference to components of recommender system 10 described above (FIGS. 1-3B). Process 500 includes generally the same steps as process 400 (FIG. 4), except process 500 additionally includes step 545 for refining the similarity measure into a composite similarity score. That is, steps 510-540 of process 500 are the same as steps 410-440 of process 400.

Step 545 follows step 540 in process 500. At step 545, the similarity measure calculated in step 530 is refined into a composite similarity score. Refining the similarity measure into the composite similarity score can include refining or adjusting the results of step 530 based on application-specific logic and the actual data in initial dataset 35. Step 545 can be carried out by composite similarity score calculation module 68 in composite similarity score calculation step 168 (FIGS. 1-2).

Steps 550-560 of process 500 are also generally the same as steps 450-460 in process 400, however, a recommendation is generated based on the similar pairs of rows in initial dataset 35 (as determined in step 540) and also further based on the composite similarity score calculated in step 545, rather than the similarity measure calculated in step 530. Accordingly, process 500 represents an optional additional step for refining the similarity measure prior to generating and outputting final recommendations compared to process 400.

In addition to the benefits described above with respect to process 400 shown in FIG. 4, refining the results in step 545 (i.e., after calculating an initial similarity measure in step 530) can focus process 500 on important elements of the initial dataset and apply the proper weight to those elements without having this weighting overwhelm the similarity measure and any recommendations generated in process 500. The other steps in process 500 can be readily combined with step 545 to refine the similarity measure if so desired for a particular application. Accordingly, process 500 allows the binary representation transformation (i.e., step 520) to be applied more flexibly in a situation-specific manner.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of measuring similarity for a sparsely populated dataset, the method comprising:
identifying fields in an initial dataset, the initial dataset including populated fields and null fields;
generating, by a computer device, a binary representation dataset that corresponds to the initial dataset by representing the populated fields of the initial dataset with a first binary value and representing the null fields of the initial dataset with a second binary value such that each of the fields in the initial dataset has a corresponding field in a corresponding position in the binary representation dataset, wherein the binary representation dataset is organized in rows and columns;
calculating a similarity measure for one or more pairs of rows of the binary representation dataset;
comparing, based on the similarity measure, each of the one or more pairs of rows of the binary representation dataset to a corresponding pair of rows in the initial dataset to identify similar pairs of rows in the initial dataset;
generating a recommendation based on the similar pairs of rows in the initial dataset; and
outputting the recommendation.

2. The method of claim 1, wherein the initial dataset and the binary representation dataset have same dimensions; and wherein each of the fields in the initial dataset has one and only one corresponding field in the binary representation dataset.

3. The method of claim 1, wherein generating the binary representation dataset further comprises maintaining a key column from the initial dataset in the binary representation dataset to identify each of the rows of the binary representation dataset.

4. The method of claim 1, wherein the populated fields in the initial dataset are populated with numerical values, textual values, or a combination of numerical and textual values.

5. The method of claim 1 and further comprising refining the similarity measure into a composite similarity score before generating the recommendation;
wherein generating the recommendation further includes generating the recommendation based on the composite similarity score.

6. The method of claim 5, wherein refining the similarity measure further includes modifying the weight of one or more attributes of the initial dataset in the similarity measure.

7. The method of claim 5, wherein refining the similarity measure further includes excluding the similarity measure for one or more pairs of rows of the binary representation dataset.

8. The method of claim 1, wherein the initial dataset is a combined dataset that includes data from multiple data sources; and wherein the data from the multiple data sources includes multiple standardized data structures having one or more non-overlapping attributes.

9. The method of claim 1, wherein the initial dataset includes one or more null fields in one or more rows of the initial dataset.

10. The method of claim 1, wherein the initial dataset includes one or more null fields in each row of the initial dataset.

11. A system for measuring similarity for a sparsely populated dataset, the system comprising:
an initial dataset that includes populated fields and null fields;
one or more processors; and
computer-readable memory encoded with instructions that, when executed by the one or more processors, cause the system to:
identify fields in the initial dataset;
generate a binary representation dataset that corresponds to the initial dataset by representing the populated fields of the initial dataset with a first binary value and representing the null fields of the initial dataset with a second binary value such that each of the fields in the initial dataset has a corresponding field in a corresponding position in the binary representation dataset, wherein the binary representation dataset is organized in rows and columns;
calculate a similarity measure for one or more pairs of rows of the binary representation dataset;
compare, based on the similarity measure, each of the one or more pairs of rows of the binary representation dataset to a corresponding pair of rows in the initial dataset to identify similar pairs of rows in the initial dataset;
generate a recommendation based on the similar pairs of rows in the initial dataset; and
output the recommendation.

12. The system of claim 11, wherein the initial dataset and the binary representation dataset have same dimensions; and wherein each of the fields in the initial dataset has one and only one corresponding field in the binary representation dataset.

13. The system of claim 11, wherein generating the binary representation dataset further comprises maintaining a key column from the initial dataset in the binary representation dataset to identify each of the rows of the binary representation dataset.

14. The system of claim 11, wherein the populated fields in the initial dataset are populated with numerical values, textual values, or a combination of numerical and textual values.

15. The system of claim 11 wherein the instructions, when executed by the one or more processors, further cause the system to refine the similarity measure into a composite similarity score before generating the recommendation; and wherein the recommendation is based on the composite similarity score.

16. The system of claim 15, wherein the instructions that, when executed by the one or more processors, cause the system to refine the similarity measure further cause the system to modify the weight of one or more attributes of the initial dataset in the similarity measure.

17. The system of claim 15, wherein the instructions that, when executed by the one or more processors, cause the system to refine the similarity measure further cause the system to exclude the similarity measure for one or more pairs of rows of the binary representation dataset.

18. The system of claim 11, wherein the initial dataset is a combined dataset that includes data from multiple data sources; and wherein the data from the multiple data sources includes multiple standardized data structures having one or more non-overlapping attributes.

19. The system of claim 11, wherein the initial dataset includes one or more null fields in one or more rows of the initial dataset.

20. The system of claim 11, wherein the initial dataset includes one or more null fields in each row of the initial dataset.
